(19) United States
(12) Patent Application Publication
(10) Pub. No.: US 2010/0045650 A1
(43) Pub. Date: Feb. 25, 2010

(54) ACTIVE MATRIX DISPLAY DEVICE WITH OPTICAL FEEDBACK AND DRIVING METHOD THEREOF

(75) Inventors: David Andrew Fish, Redhill Surry (GB); Steven Charles Deane, Redhill Surry (GB); Nicola Bramante, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,968

(22) PCT Filed: Nov. 21, 2007
(86) PCT No.: PCT/IB2007/054735

§ 371 Date: May 22, 2009

(30) Foreign Application Priority Data
Nov. 28, 2006 (EP) 06124869.6

(51) Int. Cl. G09G 5/00; G09G 3/30

(52) U.S. Cl. 345/211; 345/77

(57) ABSTRACT

An active matrix display device comprises an array of display pixels, each pixel comprising a current-driven light emitting display element (2), a drive transistor (22) for driving a current through the display element (2) and a storage capacitor (30) for storing a voltage to be used for addressing the drive transistor (22). A discharge transistor (36) is used for discharging the storage capacitor (30) thereby to switch off the drive transistor in dependence on the light output of the display element (2). Reading circuitry (70) is used for monitoring the charge on a discharge capacitor (40), the pixel data is corrected in response to the reading circuitry measurements. This can extend the lifetime of the display.

### FIELD OF THE INVENTION

The invention relates to an active matrix display device, particularly but not exclusively an active matrix electroluminescent display device having thin film switching transistors associated with each pixel.

### BACKGROUND OF THE INVENTION

Matrix display devices employing electroluminescent, light-emitting, display elements are well known. The display elements may comprise organic thin film electroluminescent elements, for example using polymer materials, or else light-emitting diodes (LEDs) using traditional III-V semiconductor compounds. Recent developments in organic electroluminescent materials, particularly polymer materials, have demonstrated their ability to be used practically for video display devices. These materials typically comprise one or more layers of a semi-conducting conjugated polymer sandwiched between a pair of electrodes, one of which is transparent and the other of which is of a material suitable for injecting holes or electrons into the polymer layer.

The polymer material can be fabricated using a CVD process, or simply by a spin coating technique using a solution of a soluble conjugated polymer. Ink-jet printing may also be used. Organic electroluminescent materials can be arranged to exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-addressed display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

FIG. 1 shows the layout of an active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in FIG. 1 for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Typically, the thickness of the organic electroluminescent material layer is between 100 nm and 200 nm. Typical examples of suitable organic electroluminescent materials, which can be used for the elements are known and described in EP-A-0 717446. Conjugated polymer materials as described in WO96/36959 can also be used.

The most basic pixel circuit has an address transistor, which is turned on by a row address pulse on the row conductor. When the address transistor is turned on, a voltage on the column conductor is used to drive a current source in the form of a drive transistor and a storage capacitor.

In pixel circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

It has been recognized that a current-addressed pixel (rather than a voltage-addressed pixel) can reduce or eliminate the effect of transistor variations across the substrate. For example, a current-addressed pixel can use a current mirror to sample the gate-source voltage on a sampling transistor through which the desired pixel drive current is driven. The sampled gate-source voltage is used to address the drive transistor. This partly mitigates the problem of uniformity of devices, as the sampling transistor and drive transistor are adjacent each other over the substrate and can be more accurately matched to each other. Another current sampling circuit uses the same transistor for the sampling and driving, so that no transistor matching is required, although additional transistors and address lines are required.

There have also been proposals for voltage-addressed pixel circuits, which compensate for the aging of the LED material. For example, various pixel circuits have been proposed in which the pixels include a light-sensing element. This element is responsive to the light output of the display element and acts to leak stored charge on the storage capacitor in response to the light output, so as to control the integrated light output of the display during the address period.

FIG. 2 shows one example of pixel layout for this purpose. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

A photodiode 27 discharges the gate voltage stored on the capacitor 24. The EL display element 2 will no longer emit when the gate voltage on the drive transistor 22 reaches the threshold voltage, and the storage capacitor 24 will then stop discharging. The rate at which charge is leaked from the photodiode 27 is a function of the display element output, so that the photodiode 27 functions as a light-sensitive feedback device. It can be shown that the integrated light output, taking into the account the effect of the photodiode 27, is given by:

$${L}_{T} = \frac{{C}_{S}}{{η}_{PD}} ( V ( 0 ) - {V}_{T} ) \qquad [ 1 ]$$

In this equation, η_{PD} is the efficiency of the photodiode, which is very uniform across the display, C_{S} is the storage capacitance, V(0) is the initial gate-source voltage of the drive transistor and V_{T} is the threshold voltage of the drive transistor. The light output is therefore independent of the EL display element efficiency and thereby provides aging compensation. However, V_{T} varies across the display so it will exhibit some non-uniformity.

One further issue is that as the capacitor holding the gate-source voltage is discharged, the drive current for the display element drops gradually. Thus, the brightness tails off. This gives rise to a lower average light intensity.

These issues have been addressed in a modification in which the drive transistor is controlled to provide a constant light output from the display element. Reference is made to WO 04/084168. The optical feedback, for aging compensation, is used to alter the timing of operation (in particular the turning on) of a discharge transistor, which in turn operates to switch off the drive transistor rapidly. This can be thought of as a “snap-off” optical feedback system. The timing of operation of the discharge transistor can also be dependent on the data voltage to be applied to the pixel. In this way, the average light output could be higher than schemes which switch off the drive transistor more slowly in response to light output. The display element can thus operate more efficiently.

Furthermore, any drift in the threshold voltage of the drive transistor will manifest itself as a change in the (constant) brightness of the display element. As a result, the optical feedback circuit can also compensate for variations in output brightness resulting both from LED ageing and drive transistor threshold voltage variations.

This invention relates to this type of “snap-off” optical feedback pixel. This pixel provides good compensation for ageing of the display element, and can also compensate for variations in the drive transistor threshold voltage across the substrate. However, the voltage induced threshold variations of amorphous silicon transistors, in particular, still provide a limit to the lifetime of the display, as the optical feedback system can only tolerate variations in threshold voltage to a certain limit. Beyond this limit of threshold voltage variation, the pixel circuit will not be able to provide enough current to the display element over the full drive period to reach the desired brightness output.

The desire to provide better threshold voltage compensation has been recognized, and WO 2005/022498 discloses an arrangement with optical feedback, and with additional compensation for threshold voltage variation, using external modification of the pixel drive signals. There is still, however, a need to provide increased tolerance of the circuit to ageing of circuit components, including threshold voltage variations of the drive transistor but also ageing of the display element and changes in the characteristics of the other components in the circuit.

### SUMMARY OF THE INVENTION

According to the invention, there is provided an active matrix display device comprising an array of display pixels, each pixel comprising:
a current-driven light emitting display element;
a drive transistor for driving a current through the display element;
a storage capacitor for storing a voltage to be used for addressing the drive transistor;
a discharge transistor for discharging the storage capacitor thereby to switch off the drive transistor;
a discharge capacitor between the gate of the discharge transistor and its source, and
a light-dependent device for controlling the timing of the operation of the discharge transistor by charging or discharging the discharge capacitor in dependence on the light output of the display element,
   wherein the device further comprises:
reading circuitry for monitoring the charge on the discharge capacitor; and
data correction means for correcting pixel data to be applied to the pixel in response to the reading circuitry measurements.

The optical feedback in this arrangement is for aging compensation particularly of the display element, and is used to alter the timing of operation (in particular the turning on) of a discharge transistor, which in turn operates to switch off the drive transistor rapidly. This timing is also dependent on the data voltage applied to the pixel. In this way, the average light output can be higher than schemes which switch off the drive transistor more slowly in response to light output. The display element can thus operate more efficiently.

Inaccuracies in the threshold voltage compensation of the drive transistor will manifest themselves as a change in the (constant) brightness of the display element. As a result, the optical feedback circuit compensates for variations in output brightness resulting both from LED ageing and drive transistor threshold voltage variations.

In addition to this two-level compensation, there is also external data correction, which uses a measurement of the charge stored or flowing from the discharge capacitor. In this way, a part of the pixel circuit which is already provided for the in-pixel optical feedback is used to provide a further measurement of any remaining ageing effects. This avoids the need for additional pixel circuitry to provide a third level of compensation.

This enables the optical feedback function to remain effective in compensating for threshold voltage variations for longer, increasing the lifetime of the display using the pixel circuit.

The light-dependent device may be adapted to charge or discharge the discharge capacitor during an addressing period, and the reading circuitry is adapted to perform at least two charge sensing operations at predetermined times into the addressing period after the addressing of the pixel with known data. These two measurements can be used to determine independently any remaining LED ageing effects and drive transistor threshold variations.

The charge sensing operations can be carried during start up and/or shut down of the display device.

In another example, the light-dependent device may be adapted to charge or discharge the discharge capacitor during an addressing period, and the reading circuitry is adapted to perform a charge measurement at the end of the addressing period after the discharge transistor has been switched on. This measures charge stored on the discharge capacitor at the end of the addressing period. With knowledge of the initial charge (which may depend on the pixel data), this charge measurement can be used as a indicator of the total light output, and thereby includes all ageing effects.

The charge measurement can be performed in parallel for all columns of pixels, and the device can then further comprises a signal processor to modify input data in response to the charge measurement.

Alternatively, the device can further comprise a multiplexer for multiplexing the charge measurement signals from different columns of pixels, a memory for storing charge measurement signals and a signal processor to modify input data in response to the charge measurement. The multiplexer is preferably integrated with pixel array.

A current source transistor can be employed for driving a predetermined current through the drive transistor, with the storage capacitor adapted to store a resulting drive transistor gate-source voltage, which is a function of the threshold voltage of the drive transistor. This provides another level of threshold voltage correction.

Each pixel preferably further comprises a bypass transistor connected between the source of the drive transistor and a bypass line. This is used as a current source circuit to drive a known current through the drive transistor, and thereby enable the storage capacitor to store a voltage, which is a function of the threshold voltage of the drive transistor.

Each pixel may further comprise an address transistor connected between a data signal line and an input to the pixel. The data signal on the data signal line can be provided by the address transistor to the gate of the discharge transistor. The discharge transistor is biased in use such that this results in the discharge transistor being turned off until the discharge capacitor has been charged or discharged by an amount dependent on the data voltage.

Each pixel preferably further comprises a charging transistor connected between a charging line and the gate of the drive transistor. This is used to charge the storage capacitor to a voltage, which corresponds to a fully on condition of the drive transistor, and is required for n-type drive transistors with a common cathode display configuration.

The current-driven light emitting display element preferably comprises an electroluminescent display element.

The invention also provides a method of driving an active matrix display device comprising an array of display pixels each comprising a drive transistor and a current-driven light emitting display element, the method comprising, for each addressing of the pixel:
applying a pixel drive voltage to an input of the pixel;
storing a voltage derived from the pixel drive voltage on a discharge capacitor;
charging a storage capacitor to a drive voltage, and driving a current through the display element by applying the storage capacitor voltage to the drive transistor thereby illuminating the display element;
switching on a discharge transistor using charge flow through a light dependent device illuminated by the light output of the display element, the charge flow charging or discharging the discharge capacitor; and
discharging the storage capacitor using the discharge transistor thereby to turn off the drive transistor,
wherein the method further comprises monitoring the charge on the discharge capacitor and correcting pixel data to be applied to the pixel in response to the charge monitoring.

### BRIEF DESCRIPTION OF THE DRAWINGS

The invention will now be described by way of example with reference to the accompanying drawings, in which:

FIG. 1 shows a known EL display device;

FIG. 2 shows a known pixel design, which compensates for differential aging;

FIG. 3 shows a second known pixel circuit;

FIG. 4 is a timing diagram for explaining the operation of the circuit of FIG. 3;

FIG. 5 shows a third known pixel circuit;

FIG. 6 is a timing diagram for explaining the operation of the circuit of FIG. 5;

FIG. 7 shows a pixel circuit and associated external circuitry of the invention;

FIG. 8 is a timing diagram for explaining the known operation of the circuit of FIG. 7;

FIG. 9 shows the dependence of a correction voltage on the initial data voltage;

FIG. 10 is shows part of the pixel circuit of FIG. 7 for modeling the behavior of the optical feedback element;

FIG. 11 shows circuitry for implementing a first way of providing external data correction;

FIG. 12 shows circuitry for implementing a second way of providing external data correction;

FIG. 13 shows a multiplexer used in the circuit of FIG. 12;

FIG. 14 is a table to show a first method of reading signals from the pixel array in sequence;

FIGS. 15A and 15B are tables to show a second method of reading signals from the pixel array in sequence; and

FIG. 16 is a table to show a third method of reading signals from the pixel array in sequence.

It should be noted that these Figures are diagrammatic and not drawn to scale. Relative dimensions and proportions of parts of these Figures have been shown exaggerated or reduced in size, for the sake of clarity and convenience in the drawings.

### DETAILED EMBODIMENTS

FIG. 3 shows an example of “snap-off” pixel schematic, which is disclosed in WO 04/084168.

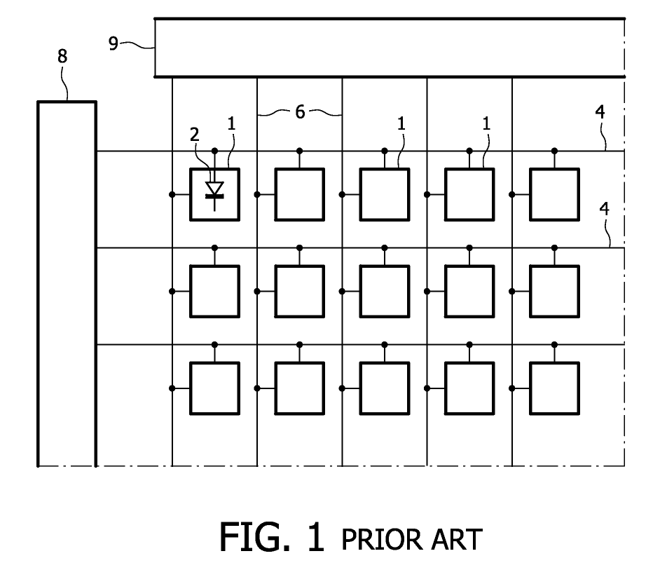

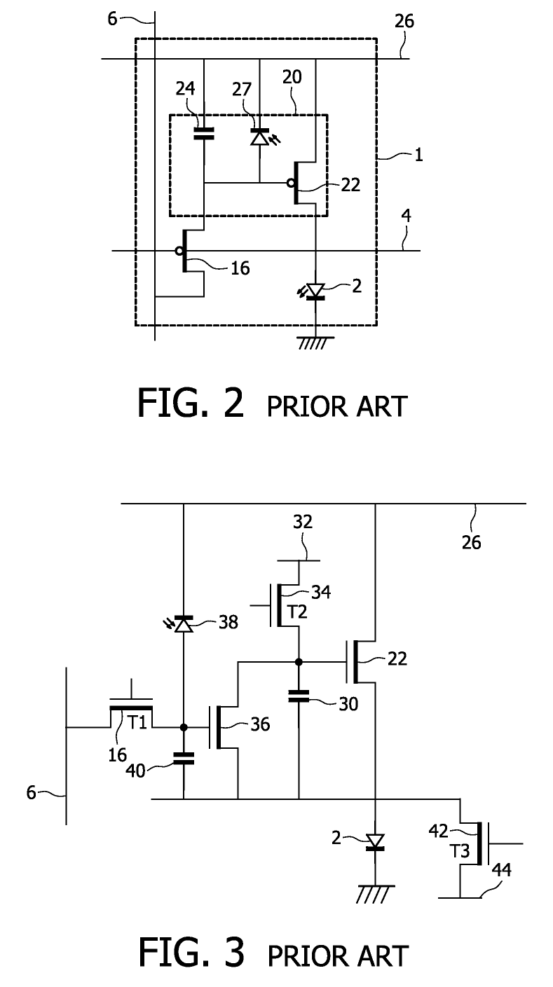

The same reference numerals are used to denote the same components as in FIG. 2, and the pixel circuit is for use in a display such as shown in FIG. 1. The circuit of FIG. 3 is suitable for implementation using amorphous silicon n-type transistors.

The gate-source voltage for the drive transistor 22 is again held on a storage capacitor 30. This capacitor is charged to a fixed voltage from a charging line 32, by means of a charging transistor 34 (T2). Thus, the drive transistor 22 is driven to a constant level, which is independent of the data input to the pixel when the display element is to be illuminated. The brightness is controlled by varying the duty cycle, in particular by varying the time when the drive transistor is turned off.

The drive transistor 22 is turned off by means of a discharge transistor 36, which discharges the storage capacitor 30. When the discharge transistor 36 is turned on, the capacitor 30 is rapidly discharged and the drive transistor turned off.

The discharge transistor is turned on when the gate voltage reaches a sufficient voltage. A photo sensor 38 (shown as a photodiode) is illuminated by the display element 2 and generates a photocurrent in dependence on the light output of the display element 2. This photocurrent charges a discharge capacitor 40, and at a certain point in time, the voltage across the capacitor 40 will reach the threshold voltage of the discharge transistor 40 and thereby switch it on. This time will depend on the charge originally stored on the capacitor 40 and on the photocurrent, which in turn depends on the light output of the display element.

Thus, the data signal provided to the pixel on the data line 6 is supplied by the address transistor 16 (T1) and is stored on the discharge capacitor 40. A low brightness is represented by a high data signal (so that only a small amount of additional charge is needed for the transistor 36 to switch on) and a high brightness is represented by a low data signal (so that a large amount of additional charge is needed for the transistor 36 to switch on).

This circuit thus has optical feedback for compensating ageing of the display element, and also has threshold compensation of the drive transistor 22, because variations in the drive transistor characteristics will also result in differences in the display element output, which are again compensated by the optical feedback. For the transistor 36, the gate voltage over threshold is kept very small, so that the threshold voltage variation is much less significant.

As shown in FIG. 3, each pixel also has a bypass transistor 42 (T3) connected between the source of the drive transistor 22 and a bypass line 44. This bypass line 44 can be common to all pixels. This is used to ensure a constant voltage at the source of the drive transistor when the storage capacitor 30 is being charged. Thus, it removes the dependency of the source voltage on the voltage drop across of the display element, which is a function of the current flowing. Thus, a fixed gate-source voltage is stored on the capacitor 30, and the display element is turned off when a data voltage is being stored in the pixel.

It should be noted that the discharge transistor is not essential to the operation of the circuit.

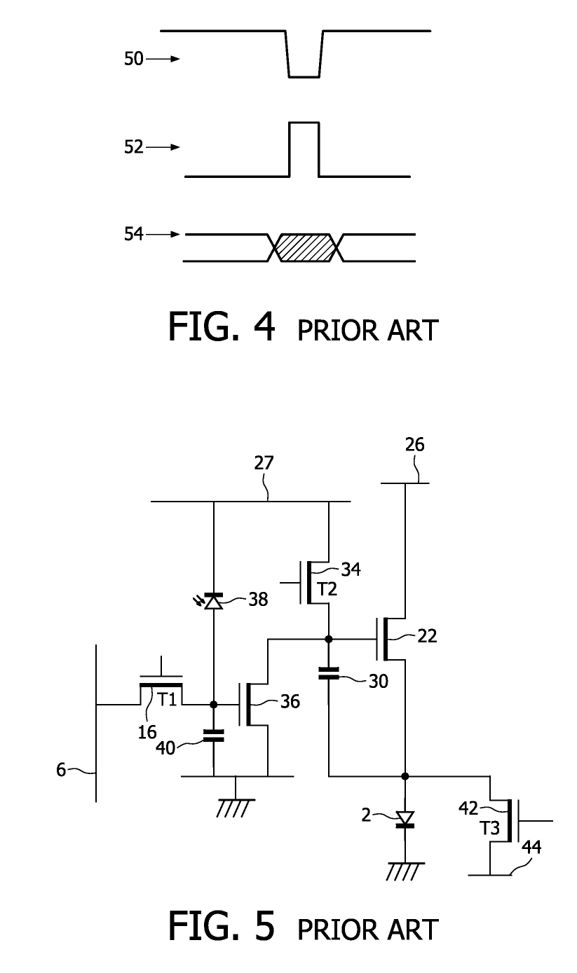

FIG. 4 shows timing diagrams for the operation of the circuit of FIG. 3 and is used to explain the circuit operation in further detail.

The power supply line has a switched voltage applied to it. Plot 50 shows this voltage. During the writing of data to the pixel, the power supply line 26 is switched low, so that the drive transistor 22 is turned off. This enables the bypass transistor 42 to provide a good ground reference.

The control lines for the three transistors T1, T2, T3 are connected together, and the three transistors are all turned on when the power supply line is low. This shared control line signal is shown as plot 52.

Turning on T1 has the effect of charging the discharge capacitor 40 to the data voltage. Turning on T2 has the effect of charging the storage capacitor 30 to the constant charging voltage from charging line 32, and turning on T3 has the effect of bypassing the display element 2 and fixing the source voltage of the drive transistor 22. As shown in plot 54, data (the hatched area) is applied to the pixel during this time.

In order to avoid the need for power line switching, the arrangement shown in FIG. 5 can be used. The same reference numerals are used for the same components, and the circuit is again shown implemented with n-type transistors only, and is therefore suitable for implementation using amorphous silicon transistors. In this circuit, the voltage on the power supply line 26 is not switched. The anode of the display element is no longer connected to the lower terminal of the discharge capacitor 40, and this enables the voltage on the bypass line to be made independent of the low voltage line of the remainder of the pixel.

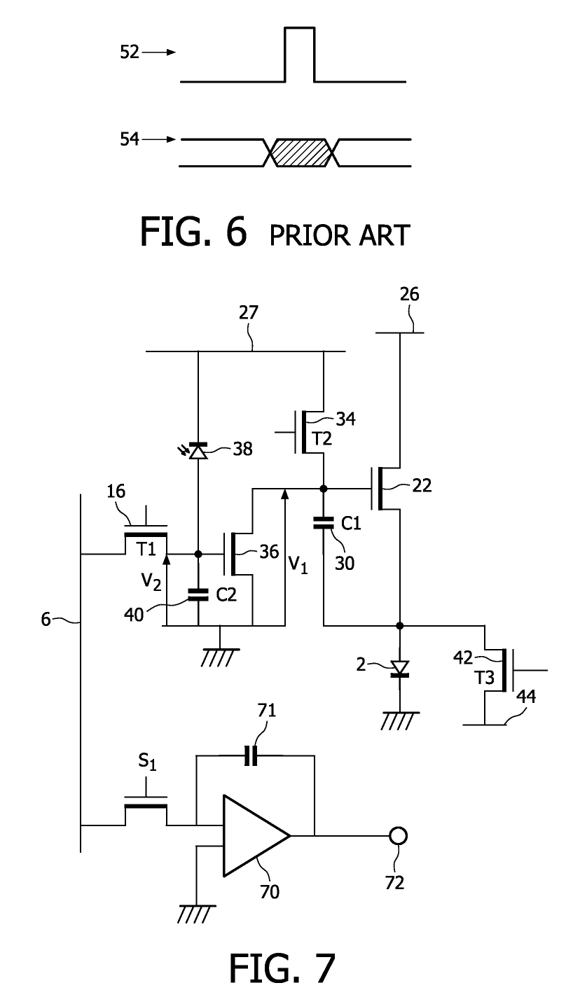

FIG. 6 shows the known timing diagram for this circuit. The storage of data in the pixel is carried out when all three transistors T1, T2, T3 are turned on, by plot 52.

In this circuit, the voltage applied to the bypass line 44 is selected to be below the threshold of the display element 2, so that the display element is turned off during pixel programming, without needing to switch the voltage on the power supply line 26. Avoiding power line switching makes implementation of the driver circuitry less complicated.

One problem with this approach is that the circuit can only provide limited compensation for threshold voltage variations of the drive transistor. In the case of amorphous silicon drive transistors, these variations will be much more significant than the variations in pixel characteristics resulting from the ageing of the display element.

One way to address this problem proposed by the applicant is to provide additional compensation for the threshold voltage of the drive transistor, and this can be implemented using the bypass line and bypass transistor as a current source, which causes a known current to be driven through the drive transistor 22. Thus, the transistor 42 can be operated as a current controlling device, which governs the current drawn through the drive transistor 22. This can be used to sample the drive transistor threshold voltage, so that the initial voltage stored on capacitor 30 is no longer a constant voltage, but has a variable component dependent on the drive transistor characteristics.

Even with this additional current sensing step, further improvements to the correction, which can be implemented by the circuit, will give rise to enhanced lifetime for the circuit.

The invention provides an additional or alternative technique for improving the correction capability of the circuit.

One example of circuit required is shown in FIG. 7, and it will be seen that the circuit corresponds to FIG. 6, but with the addition of a charge sensing arrangement 70 associated with each column.

In a first example of the invention, a charge-sensing step is performed at defined intervals. The combination of the discharge capacitor 40 (C₂), the addressing transistor 16 (T1) and the photodiode or phototransistor 38 can be used as a charge storage cell whilst the discharge transistor 36 remains off.

A silicon IC (for example of the type used for flat X-ray detectors) can be connected to the columns of the display via switches S₁ to read out the charge from the capacitor 40 at the defined interval.

Before the discharge transistor 36 has turned on, the change in charge on the capacitor 40 is controlled purely by the optical feedback system. As a result, the charge stored on capacitor 40 will represent the drive TFT drift and LED degradation. If a current programming stage has been used to sample the drive TFT threshold voltage (as outlined above), the charge represents the residual errors that are left from the current programming stage.

Two measurements of a pixel are required to correct for the two degradation mechanisms in the pixel (namely OLED ageing and TFT threshold voltage drift). The charge line 27 can be modulated between two different values in two fields to provide different drive conditions for the LED.

The two required measurements can be obtained by taking charge readings before the emission ceases, at the same time in each field. Considering a simple model of the pixel, it can be seen why two measurements are required. The luminance generated by the drive TFT is:

L=η_{OLED}β(V_{CHARGE}−V_{T})²/2 [2]

where, η_{OLED} is the OLED efficiency, β is the drive TFT trans-conductance, V_{T} is the threshold of the drive TFT, V_{CHARGE} is the gate-source voltage of the drive TFT. This equation maps the drive TFT output current to a luminance level. The charge stored on the capacitor C₂ is then given by:

Q=T_{F}η_{PS}η_{OLED}β(V_{CHARGE}−V_{T})²/2 [3]

where T_{F} is the field time and η_{PS} is the photo-sensor efficiency. This equation represents the charge flow resulting from the luminance L from equation [2] over the field period. Two measurements are required to determine the two parameters i.e. V_{T} and T_{F}η_{PS}η_{OLED}β/2. These parameters can be calculated with the formula below. New values of the gate source voltage V_{GS} for the drive TFT can also be calculated. Q_{T} represents the input data:

$${V}_{T} = \frac{{V}_{1} \sqrt{{Q}_{2}} - {V}_{2} \sqrt{{Q}_{1}}}{\sqrt{{Q}_{2}} - \sqrt{{Q}_{1}}} \\ α = {T}_{F} {η}_{PS} {η}_{OLED} β = \frac{{V}_{2}}{{V}_{2} - {V}_{T}} \\ {V}_{GS} = {V}_{T} + \sqrt{\frac{{Q}_{T}}{α}} \qquad [ 4 ]$$

These two measurements could be taken during the start-up or shut down of the display, during which a fixed plain field image (test image) can be displayed. These test images can be display for a few tens of milliseconds.

The voltage is changed on line 27 (charge line) as this dictates the gate-source voltage of the drive TFT, and therefore the luminance and the rate of charging of the storage capacitor 40. Therefore, by integrating the charge for a fixed time interval, it is possible to obtain two results for the two different charge voltages i.e. Q1 and Q2 that correspond to charge voltages V1 and V2. This enables equation [4] to be solved, and with simple circuit timing.

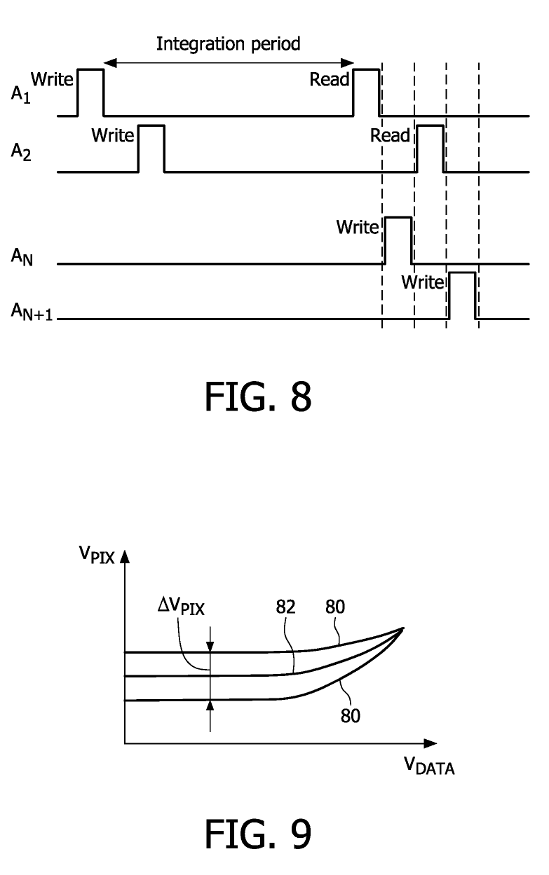

FIG. 8 illustrates a drive scheme for this example of the invention.

Each line of the display is addressed in turn but with a line time blanking between each write event. FIG. 8 shows the addressing time for each address line 1 to N+1 in turn. After a suitable integration period 80, a read operation is carried out. As the read operation uses the same column conductors as the write operation, the read and write operations are interleaved, as shown. In this way, all pixels are addressed for the same integration period, which will be sufficiently short that the discharge transistor 36 does not turn on, and the readout phase will be completed rapidly.

This process can be performed twice with different charge line voltages to enable the two measurements to be made from every pixel and the time taken could be roughly that of five field periods. The storage capacitor 40 is reset after each of the two measurements, and the integration period may be approximately 5 ms.

It is also possible to make the measurements when the display is running normally. In this case, the information read out from the capacitor 40 would have to be written back immediately, so that the optical feedback process can continue. This could be done by buffering and scaling the voltage on the output of the charge amplifier and switching this voltage onto the display column. This is of course more complicated and less desirable than the use of the start up or shut down periods of the display.

A benefit of charge sensing is that the threshold voltage of the discharge transistor 36 can also be found. It is advantageous to do this because there will be small amounts of drift in this device which will effect the black level of the display. If the charge on the capacitor 40 (capacitance C₂) is sensed after the luminance has turned off (i.e. the discharge transistor 36 has turned on) then the charge on the capacitor 40 will be C₂V_{TL}. Tracking the changes in this charge will enable the data to be corrected using signal processing. This could for example be implemented in a further two field periods in the start-up or shutdown phase of the display.

The scheme can also take account of the effects of dark currents in the photosensitive device. These will add to the charge readout of the pixel.

To take account of dark currents, three measurements can be taken before the OLED turns off and subtractions can be used to derive change values (rather than using absolute values). This enables removal of some of the effects of dark current. This will be effective if conditions at startup remain the same over the period of use of the display, for example if the temperature remains the same.

The calculations and measurements outlined above enable the prediction of the required gate-source voltage values for the drive TFT and the threshold voltage variations of the discharge transistor 36.

The data readout requires the charge line 27 to be modulated on a pixel-by-pixel basis. This requires the charge line 27 to become a data line (rather than a single common line), which is coupled to the column driver, and it will therefore run parallel to the standard data columns of the display.

In a circuit in which the drive transistor is voltage-programmed (for example the circuit of FIG. 3 but without current programming using the transistor 42), modulating the charge line 27 will have the desired effect of providing a different drive TFT output current.

However, if the drive transistor gate-source voltage is obtained by a current sampling technique, as discussed above, then modulating the charge line voltage will not alter the drive TFT output current. In this case, the current sampling step needs to be altered. The current is given by:

$$I = {Q}_{T} \frac{β}{α}$$

Thus, the trans-conductance of the drive TFT needs to be known, and this can easily be calculated. The transistor 42 can then be controlled to supply the desired current. The parameters of the TFT 42 are known so that the required gate-source voltage can be calculated. In this case, the line 44 needs to run parallel to the columns as a second data line.

In all cases, average values of the required gate source voltage of the drive TFT can be calculated, and the charge line 27 or common line 44 can then be controlled to represent the average effect, and the optical feedback system can correct the differences. In this case, the lines 27 or 44 do not need to be data lines, but can be common to all pixels or to sub-groups of pixels.

The predictions of the threshold voltage of the discharge transistor 36 can be dealt with by shifting the standard data values appropriately to take out the effect of variations across the array.

Instead of charge sensing, photocurrent sensing can also be performed. In this case, the charge sensing arrangement 70 will be arranged as a current sensing arrangement, in the form of a current to voltage converter/amplifier. The sensing in this case can again be performed at start-up or shutdown of the display. Each row of the display will have a constant data value written into the pixel and then the control line for the addressing transistor 16 and for the switch S1 are held high in turn so that the photo-current can settle. The amplifier then gives an output voltage representative of the OLED and drive TFT degradation (or current programming errors). Again, steps similar to those taken for charge sensing can be taken to make corrections.

In this version, there will be two different currents sensed in response to variations in the charge line. This process will not be able to predict the discharge transistor threshold voltage.

The approaches outlined above use multiple measurements during the optical feedback cycle to enable additional threshold voltage and LED ageing compensation calculations to be made.

The correction scheme explained above also assumes that the final pixel voltage Vpix on the storage capacitor 40 equals the threshold of the discharge TFT 36, and that there is no information about the threshold of the drive TFT and the OLED degradation in the pixel voltage. In fact, the discharge TFT 36 is not a perfect switch, and the result is that final pixel voltage Vpix can vary in response to the drive TFT and LED degradation. Thus, the final pixel voltage can be used to make corrections for these parameters.

Thus, a different and simpler approach is based on the realization that after the circuit has switched off the LED, the charge stored on the storage capacitor 40 represents the light emitted by the display and can be used to take account of the drive TFT and OLED degradation. In particular, the initial voltage and charge is known, and the end voltage is based on a change in charge, which results from the optical feedback operation. The light emitted can thus be compared with the emission required, and a simple change to the data voltage can be made to achieve a correction.

The residual effects in the circuits that need to be corrected for are again any drift in the threshold of the discharge transistor 36 and the errors in the correction of the threshold voltage of the drive TFT and the OLED luminance degradation caused by the non-infinite turn-on rate of the snap-TFT. These errors become particularly serious at low grey levels.

The voltage read out of the charge amplifier in FIG. 7 after switch off will equal:

$${V}_{OUT} = - \frac{{C}_{STORE}}{{C}_{AMP}} ( {V}_{PIX} - {V}_{REF} ) \qquad [ 5 ]$$

where C_{STORE} is the storage capacitor value, and C_{AMP} is the feedback capacitor 71 of the charge amplifier. V_{REF} is the reference voltage of the amplifier. This could be the initial voltage written into the pixel at the beginning of the field period V_{DATA} or a constant reference voltage. V_{PIX} is the voltage in the pixel on the capacitor 40 at the end of the field period. This is the important value to be measured, as it represents changes in the threshold of the discharge transistor and errors in the correction of the drive TFT and OLED.

The average luminance emitted by the pixel will be L_{AVE}. The charge stored on the storage capacitor 40 by the photo-sensor 38 will then be:

$$\begin{matrix}{Q}_{PIX} = {C}_{STORE} ( {V}_{PIX} - {V}_{DATA} ) \\ = {η}_{PD} {\int }_{t = 0}^{t = {T}_{F}} L ( t ) d t = {η}_{PD} {L}_{AVE} {T}_{F}\end{matrix} \qquad [ 6 ]$$

For the case V_{REF}=V_{DATA} then

$${V}_{OUT} = - \frac{{η}_{PD} {T}_{F}}{{C}_{AMP}} {L}_{AVE} \qquad [ 7 ]$$

or else if V_{REF} is a constant voltage reference then

$${V}_{OUT} = \frac{{C}_{STORE}}{{C}_{AMP}} ( {V}_{REF} - {V}_{DATA} ) - \frac{{η}_{PD} {T}_{F}}{{C}_{AMP}} {L}_{AVE} \qquad [ 8 ]$$

Thus, even with a constant charge amplifier reference voltage, a known offset in the output voltage is obtained, and V_{OUT} can still be used to represent the average luminance.

The change in V_{OUT} as degradation occurs is:

ΔV_{OUT}=−(C_{STORE}/C_{AMP})·ΔV_{PIX} [9]

The change in pixel voltage can thus be derived from the output voltage. Therefore, to make a correction, a value (C_{AMP}/C_{STORE})·ΔV_{PIX} is added to V_{DATA}. Assuming C_{STORE}=C_{AMP}, the correction is very simple i.e. V_{DATA}(new)=V_{DATA}+ΔV_{PIX}.

It has also been found that the final pixel voltage Vpix is dependent upon the initial pixel voltage i.e. the data V_{DATA} originally written into the pixel. The correction has been found to work particularly well if a final voltage Vpix is selected in the correction algorithm that occurs for a data voltage that corresponds to a high grey level. This works well for correction at any grey scale during operation of the display.

FIG. 9 shows the dependency of the correction voltage on the data voltage V_{DATA}. As shown, a graph of the final pixel voltage V_{PIX} versus V_{DATA} curves upwards at the higher values of V_{DATA}, which correspond to low grey levels.

The degraded forms of this curve 80 converge to the un-degraded curve 82 at high V_{DATA} therefore the ΔV_{PIX} reduces with V_{DATA}. However simulation has shown that no account of this is needed in the correction algorithm. Instead, only the ΔV_{PIX} value that corresponds to low values of V_{DATA} are needed in a correction algorithm. This is the value of ΔV_{PIX} that is independent of most V_{DATA} values, and this is used as the correction for all V_{DATA} values.

The algorithm presented above assumes an idealized case in which the photo-sensor is a perfect current source; there are no parasitic capacitances and no dark leakage currents.

One particular effect that causes error is the fact that a photo-sensor is not a perfect current source and has finite output impedance. It is, however, possible to compensate for this as shown below.

The output impedance of the photo-sensor can be modeled by giving its photo-conversion efficiency η a dependence upon voltage.

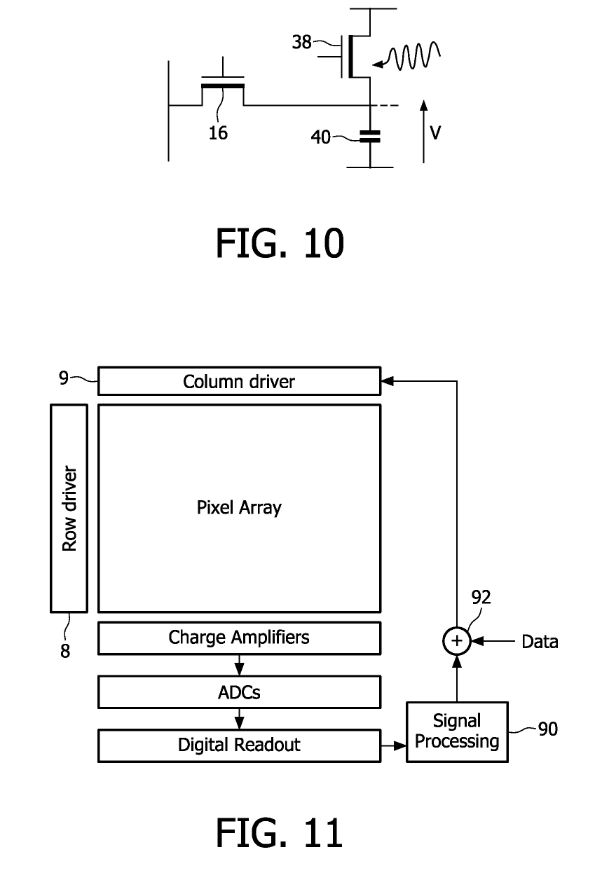

FIG. 10 shows the photo-sensor 38 and storage capacitor 40 of the optical feedback part of the circuit.

The charging of capacitor 40 follows:

$$C \frac{d V}{d t} = η ( V ) {L}_{INST}$$

which becomes

$$C {\int }_{{V}_{i}}^{{V}_{f}} \frac{d V}{η ( V )} = {L}_{AVE} {T}_{F}$$

where T_{F} is the frame time. Assuming that the photo-conversion efficiency η has the following voltage dependence:

η(V)=η₀(1+αV)

Then the integral is easily evaluated

$${L}_{AVE} = \frac{{η}_{0} {T}_{F}}{C} log ( \frac{1 + α {V}_{f}}{1 + α {V}_{i}} )$$

To make the correction, it is noted that V_{f} (final V) will change over the display lifetime and that Vᵢ (initial V) will need to be changed to make that correction. Then:

$${L}_{AVE} ( 0 ) = \frac{{η}_{0} {T}_{F}}{C} log ( \frac{1 + α {V}_{f} ( 0 )}{1 + α {V}_{i} ( 0 )} )$$

$${L}_{AVE} ( τ ) = \frac{{η}_{0} {T}_{F}}{C} log ( \frac{1 + α {V}_{f} ( τ )}{1 + α {V}_{i} ( τ )} )$$

where τ is a time variable that whose scale is comparable to the lifetime of the display. For a correction to be made the average luminance at time zero must equal the average luminance at time τ. Therefore the data voltage Vᵢ(τ) is found that makes that correction to be:

$${V}_{i} ( τ ) = \frac{1}{α} ( \frac{1 + α {V}_{f} ( τ )}{1 + α {V}_{f} ( 0 )} ( 1 + α {V}_{i} ( 0 ) ) - 1 )$$

As above, the values used for V_{f}(0) and V_{f}(τ) are for low values of Vᵢ, that is where the curve shown in FIG. 9 is flat. The value of α will be known reasonably well, but can be measured at time zero when the display is manufactured. Two luminance values must be applied to the display with two different initial voltages Vᵢ(A) and Vᵢ(B). The final voltages V_{f} will be equal (if the initial voltages were both taken from the flat part of the curve in FIG. 9). Therefore:

$$α = \frac{exp ( β Δ {L}_{AVE} )}{{V}_{i} ( A ) - {V}_{i} ( B ) exp ( β Δ {L}_{AVE} )}$$

where ΔL_{AVE} is the measured luminance difference and β=η₀T_{F}/C. This constant will be known.

More general voltage dependence of η can also be taken into account as well as any voltage dependence of capacitance C.

$$C ( V ) \frac{d V}{d t} = η ( V ) {L}_{INST}$$

$$Then \text{:} f ( {V}_{f} ) - f ( {V}_{i} ) = {L}_{AVE} {T}_{F}$$

where f is general solution to the integral. Following the procedure detailed earlier:

ƒ(V_{ƒ}(0))−ƒ(Vᵢ(0))=L_{AVE}(0)T_{F}

ƒ(V_{ƒ}(τ))−ƒ(Vᵢ(τ))=L_{AVE}(τ)T_{F}

Then L_{AVE}(τ) must equal L_{AVE}(0) so the correction voltage becomes:

Vᵢ(τ)=ƒ⁻¹(ƒ(V_{ƒ}(τ))−L_{AVE}(0)T_{F})

The function f and its inverse need to be known, and this information can be obtained by measuring the display gamma curve (i.e. L_{AVE} vs Vᵢ) at time zero when the display is manufactured. This information is then stored in the form of Look-Up-Tables and used to process and correct the data applied to the display throughout its lifetime.

It can be seen that the correction voltage used to update the display data can take account of additional non-ideal performance characteristics in the pixel circuit, particularly the optical feedback element, again improving further the extension to the lifetime of the display provided by the feedback and correction circuit.

Returning to the simpler correction scheme explained with reference to Equation [9], it will be seen that the output voltage is used to track changes over time of the pixel voltage at the end of the addressing cycle for given pixel drive conditions. These changes in final pixel voltage reflect a changing optical output of the display for the same drive conditions, and thereby incorporate all ageing effects within the pixel which are having an impact on the output brightness.

To make the correction, a store of the original value of V_{PIX} is needed (ideally this will be constant across the array so requires one value, but more values can be stored to represent variation across the array). The new values of V_{PIX} are then stored calculated from the read values V_{OUT}. If the pixels are corrected one frame at a time then the calculated value of V_{PIX} can be used immediately to calculate a corrected data value. If the pixels are corrected more slowly then memory will be required to store the V_{PIX} values. This leads to certain trade-offs in the hardware implementation, for instance the frame rate correction will require a charge amplifier and possibly analogue to digital converter per column and rapid readout into a signal processing block to calculate the data correction before the data is required for addressing the display.

If, at another extreme, one pixel is read out per line time or one pixel per field time and all of the V_{PIX} values are stored, then one charge amplifier and analogue to digital converter can be stored between all columns of the display. In this case, the analogue ICs in the system have been reduced but the memory requirements have increased.

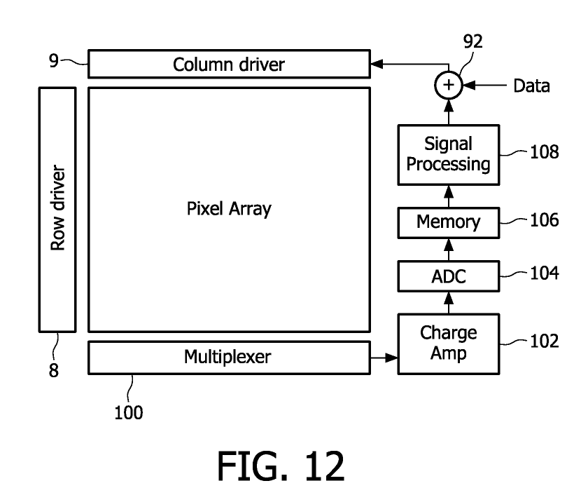

These two possible approaches are shown in FIGS. 11 and 12.

FIG. 11 shows parallel readout and real time correction, in which real time signal processing takes place in block 90, and this provides an error value to be added to the incoming data at the adder 92, before supply to the column driver 9.

FIG. 12 shows a serial readout scheme with slow correction. A multiplexer 100 is provided between the pixel array and the charge amplifiers 102 and analogue to digital converters 104. A memory 106 stores the readout data to enable serial signal processing in the processor 108.

The hardware requirements are higher in FIG. 11 due to the large number of charge amplifiers and converters. However, FIG. 12 will need a field memory. The real-time correction is non-essential as the pixel circuit itself is performing a correction. The degradation in the performance of the pixel will be slow so the method of FIG. 12 is preferred and will also be cheaper in terms of the IC requirements.

The multiplexer of FIG. 12 can also be implemented in amorphous silicon so that it essentially has zero cost.

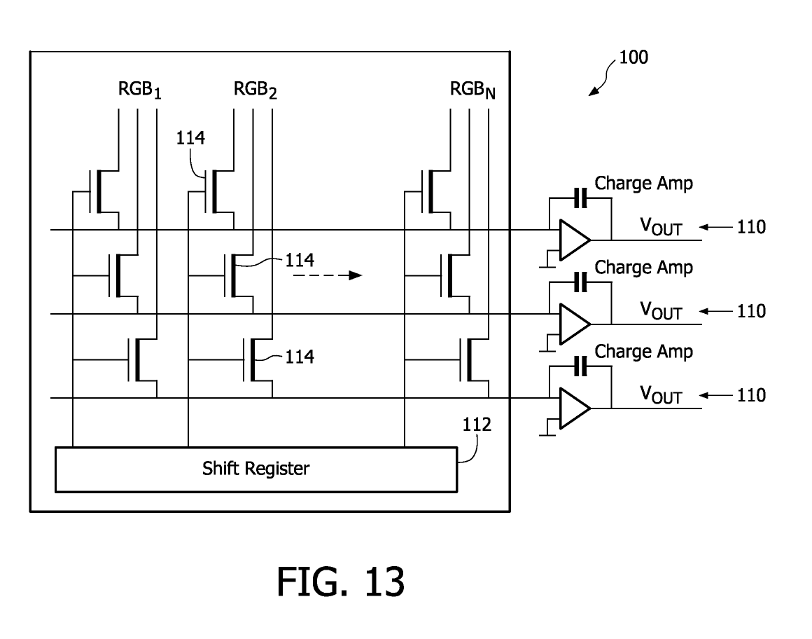

FIG. 13 shows how the multiplexing circuitry 100 can be implemented. To read one RGB pixel per row, only three charge sensing op-amps 110 and a shift register 112 are required to address the correct column multiplex switches 114. If the implementation is amorphous silicon, there may be a fear that the circuitry will fail due to threshold voltage shifts in the TFTs. However shift registers for row drivers are regularly implemented with amorphous silicon, using low and high impedance drive techniques that have some forms of TFT compensation. These schemes can be implemented in this situation as the multiplexer can be designed with a shift register that is only required to run at line rate.

The multiplexer switches will also operate only once per field and have stability similar to the pixel switch, so that there will be no degradation issue.

The integration of the multiplexer circuit onto the display substrate means the external electronics can be reduced substantially, providing a large cost benefit. The addressing of the multiplexer system must be considered carefully to ensure that all pixels in the array are read.

Most arrays have an even number of columns and rows therefore the shift register for the multiplexer could cause half of an array not to be read. An example is shown in FIG. 14.

FIG. 14 shows the reads from a 6×4 display where the read shift register operates at the same clock frequency as the row shift register. The 1's represent the pixels read from the first full cycle of the read shift register.

After the last row of the display, the next pixel read is from the first row of the display. The 2's represent the second cycle of the read shift register. The 3^{rd} cycle of the read shift register overlaps the 1's that have already been read out and misses half of the pixels in the array.

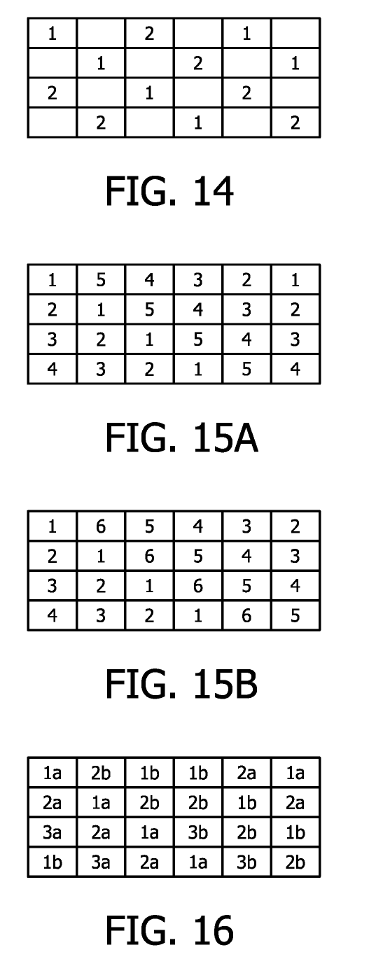

To avoid this, the read shift register can be provided with an extra clock pulse within the display blanking period to ensure its output is shifted one place for the next field of data. In this case the readout sequence is shown in FIG. 15.

FIG. 15A shows the read shift cycle numbering, and FIG. 15B shows the row shift cycle numbering, for pixel reads from a 6×4 display.

In FIG. 15A, it can be seen that during the display blanking period when all rows have been addressed, the read cycle skips one place, so that there is no readout from one of the columns. For example, the first read shift cycle misses column 5. There are 6 cycles of the row shift register for the 5 cycles of the read shift register, as seen in FIG. 15B.

Thus, all pixels in the array are read within the five cycles of the read shift register that corresponds to the six cycles of the row shift register. This of course corresponds to six field periods. Therefore a WXGA display will require 1280 fields to readout and this will be 768+1 cycles of the read shift register. Readout will occur in about 20 seconds at a field rate of 60 Hz.

Other readout schemes can be envisaged, for example using more than 3 op-amps, for example 6 or 9 or more where 2, 3 or more pixels are read per line time. The length of the read shift register will be shortened accordingly. Alternatively, the shift register can be kept the same length and multiple carry pulses sent into it. An example sequence with 2 pixel readouts per line time is shown in FIG. 16.

As shown, there are two measurements per row at the same time. For example, measurements 1a and 1b are at the same time, and measurements 2a and 2b are at the same time.

This arrangement has readout in 2.5 fields. The readout rate can also be reduced so that one pixel is read for every two or more lines. The clock rate of the read shift register will then become half or more of the row shift register.

It will be seen that there are various possible readout schemes for the charge sensing to enable external data correction in addition to the in-pixel compensation.

The examples above show a common-cathode implementation, in which the anode side of the LED display element is patterned and the cathode side of all LED elements share a common unpatterned electrode. This is the current preferred implementation as a result of the materials and processes used in the manufacture of the LED display element arrays. However, patterned cathode designs are being implemented, and this can simplify the pixel circuit.

Common-anode pixel configurations are discussed and examples given in WO 04/084168, and this invention can be implemented for common-anode pixel configurations in the same way.

The circuit is an n-type only arrangement, which are therefore suitable for amorphous silicon implementation.

The invention can also be used for implementation using a low temperature polysilicon process, in which case an n-type and p-type circuit may be preferred.

In the example above, the light dependent element is a photodiode, but pixel circuits may be devised using phototransistors or photoresistors.

A number of transistor semiconductor technologies have been mentioned above. Further variations are possible, for example crystalline silicon, hydrogenated amorphous silicon, polysilicon and even semi-conducting polymers. These are all intended to be within the scope of the invention as claimed. The display devices may be polymer LED devices, organic LED devices, phosphor containing materials and other light emitting structures.

There are alternative ways to prevent the display element emitting light during the pixel programming stage. The example above uses a bypass transistor to provide an anode voltage, which does not turn on the display element. It is instead possible to provide an isolating transistor between the drive transistor and the display element. This can be used in combination with the current sampling technique of the invention.

The invention provides a second or third line of correction for the extreme degradation of the drive TFT and the OLED over the 10 Khr lifetime of the display. The invention has been described with reference to one pixel circuit only, but other versions of a so-called “snap-off” pixel circuit can also be used.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An active matrix display device comprising an array of display pixels, each pixel comprising:
a current-driven light-emitting display element (2);
a drive transistor (22) for driving a current through the display element (2);
a storage capacitor (30) for storing a voltage to be used for addressing the drive transistor;
a discharge transistor (36) for discharging the storage capacitor (30) thereby to switch off the drive transistor (22);
a discharge capacitor (40) between the gate of the discharge transistor and its source, and
a light-dependent device (38) for controlling the timing of the operation of the discharge transistor (36) by charging or discharging the discharge capacitor in dependence on the light output of the display element (2),
wherein the device further comprises:
reading circuitry (70) for monitoring the charge on the discharge capacitor (40); and
data correction means (90) for correcting pixel data to be applied to the pixel in response to the reading circuitry measurements.

2. A device as claimed in claim 1, wherein the light-dependent device (38) is adapted to charge or discharge the discharge capacitor (40) during an addressing period, and wherein the reading circuitry is adapted to perform at least two charge sensing operations (READ) at predetermined times into the addressing period after the addressing of the pixel with known data.

3. A device as claimed in claim 2, wherein the charge sensing operations are carried during start up and/or shut down of the display device.

4. A device as claimed in claim 1, wherein the light-dependent device (38) is adapted to charge or discharge the discharge capacitor (40) during an addressing period, and wherein the reading circuitry is adapted to perform a charge measurement at the end of the addressing period after the discharge transistor (36) has been switched on.

5. A device as claimed in claim 4, wherein the charge measurement is performed in parallel for all columns of pixels, and wherein the device further comprises a signal processor (90) to modify input data in response to the charge measurement.

6. A device as claimed in claim 4, wherein the device further comprises a multiplexer (100) for multiplexing the charge measurement signals from different columns of pixels, a memory for storing charge measurement signals and a signal processor to modify input data in response to the charge measurement.

7. A device as claimed in claim 6, wherein the multiplexer (100) is integrated with pixel array.

8. A device as claimed in claim 7, wherein the multiplexer (100) and the pixel array are formed using amorphous silicon.

9. A device as claimed in claim 1, further comprising a current source transistor (42) for driving a predetermined current through the drive transistor (22), wherein the storage capacitor (30) is adapted to store a resulting drive transistor gate-source voltage, which is a function of the threshold voltage of the drive transistor.

10. A device as claimed in claim 1, wherein each pixel further comprises a bypass transistor (42) connected between the source of the drive transistor (22) and a bypass line (44).

11. A device as claimed in claim 1, wherein the storage capacitor (30) is connected between the gate and source of the drive transistor (22).

12. A device as claimed in claim 1, wherein the light-dependent device (38) controls the timing of the switching of the discharge transistor (36) from an off to an on state.

13. A device as claimed in claim 1, wherein each pixel further comprises an address transistor (16) connected between a data signal line (6) and an input to the pixel.

14. A device as claimed in claim 1, wherein the drive transistor (22) is connected between a power supply line (26) and the display element (2).

15. A device as claimed in claim 1, wherein each pixel further comprises a charging transistor (34) connected between a charging line (27) and the gate of the drive transistor (22).

16. A device as claimed in claim 1, wherein the current-driven light emitting display element (2) comprises an electroluminescent display element.

17. A method of driving an active matrix display device comprising an array of display pixels each comprising a drive transistor (22) and a current-driven light emitting display element (2), the method comprising, for each addressing of the pixel:
applying a pixel drive voltage to an input of the pixel;
storing a voltage derived from the pixel drive voltage on a discharge capacitor (40);
charging a storage capacitor (30) to a drive voltage, and driving a current through the display element by applying the storage capacitor voltage to the drive transistor (22) thereby illuminating the display element (2);
switching on a discharge transistor (36) using charge flow through a light dependent device (38) illuminated by the light output of the display element (2), the charge flow charging or discharging the discharge capacitor (40); and
discharging the storage capacitor (30) using the discharge transistor (36) thereby to turn off the drive transistor,
wherein the method further comprises monitoring the charge on the discharge capacitor (40) and correcting pixel data to be applied to the pixel in response to the charge monitoring.

18. A method as claimed in claim 17, wherein the light-dependent device (38) charges or discharges the discharge capacitor (40) during an addressing period, and wherein the charge monitoring comprises at least two charge sensing operations at predetermined times into the addressing period after the addressing of the pixel with known data.

19. A method as claimed in claim 18, wherein the charge sensing operations are carried during start up and/or shut down of the display device.

20. A method as claimed in claim 17, wherein the light-dependent device (38) charges or discharges the discharge capacitor (40) during an addressing period, and wherein the charge monitoring comprises a charge measurement at the end of the addressing period after the discharge transistor (36) has been switched on.

21. A method as claimed in claim 20, wherein the charge measurement is performed in parallel for all columns of pixels, and input data is modified in response to the charge measurement.

22. A method as claimed in claim 20, further comprising multiplexing the charge measurement signals from different columns of pixels, and storing charge measurement signals in a memory (106), the input data being modified in response to the charge measurement
